(19) United States
(12) Patent Application Publication
(10) Pub. No.: US 2022/0225048 A1
(43) Pub. Date: Jul. 14, 2022

(54) SYSTEM AND METHOD FOR MANAGING A HEADPHONES USERS SOUND EXPOSURE

(71) Applicant: Onanoff Limited Company (Ltd.), Kowloon Bay (HK)

(72) Inventors: Petur Hannes Olafsson, Hong Kong (CN); Simon Weston, Miyagi-ken (JP)

(21) Appl. No.: 17/574,554

(22) Filed: Jan. 13, 2022

Related U.S. Application Data
(60) Provisional application No. 63/137,539, filed on Jan. 14, 2021.

(51) Int. Cl. H04S 7/00; H04R 1/10; G06F 3/16

(52) U.S. Cl. CPC H04S 7/301; H04R 1/1041; G06F 17/156; H04R 2430/01; G06F 3/165

(57) ABSTRACT

A method and system for managing a user sound exposure are described herein. The method includes collecting raw audio data, calculating spectral data and a sound pressure level (SPL) from the raw audio data, comparing the calculated SPL to a predetermined threshold level of sound exposure, and applying one or more modifications to the SPL in response to a determination that the SPL is approaching the predetermined threshold level of sound exposure to ensure the SPL never reaches the predetermined threshold level of sound exposure.

### CROSS-REFERENCE TO RELATED APPLICATIONS SECTION

This application is a U.S. Non-Provisional patent application that claims priority to U.S. Provisional Patent Application Ser. No. 63/137,539 filed on Jan. 14, 2021, the entire contents of which are hereby incorporated by reference in their entirety.

### FIELD OF THE EMBODIMENTS

The present invention relates to a system and method for managing a user sound exposure while wearing headphones, headsets, or ear buds.

### BACKGROUND OF THE EMBODIMENTS

Headphones, headsets, and ear buds have found widespread use in consumer applications, such as listening to podcasts, audio books, online education, and for traditional entertainment purposes. However, an accumulated exposure to acoustic energy noise may lead to hearing damage and listening fatigue. In fact, the Center for Disease Control (CDC) estimates that 22 million workers are exposed to potentially damaging noise at work each year. However, such hearing loss is preventable. Organizations, such as the Occupational Safety and Health Administration (OSHA) and the World Health Organization (WHO), have developed standard guidelines to specify the maximum allowable sound exposure for users.

Thus, what is needed is a system and method for managing a user's sound exposure when wearing headphones. Moreover, it would be beneficial for such system to be built into the headphones, headsets, or ear buds that may: sample the actual sound level experienced by the user, compute a total exposure level, and autonomously adjust the aggregate sound pressure output level, spectral content, and ambient noise reduction level for the headphones, headsets, or ear buds to avoid exceeding an exposure limit and to prevent hearing loss.

### REVIEW OF RELATED ART

JP 2013538520 A describes a method for adjusting volume in a headset based on accumulated acoustic energy density exposure. A sound pressure value of a microphone positioned in a user's ear canal is measured. A current accumulated acoustic energy density exposure is determined based on sound pressure values measured. The maximum volume in the headset is adjusted based on a comparison of the current accumulated energy density exposure to a predetermined threshold.

U.S. Pat. No. 6,826,515 B2 describes a method and apparatus for monitoring and controlling exposure to noise related to a headset. The method includes sampling an input sound signal to produce samples of the input sound signal; calculating, from these samples, a headset sound level corresponding to the input sound signal; calculating cumulative exposure of a headset user to the headset sound level at a specific point in time; and calculating a gain adjustment for the input sound signal to ensure that the total sound to which the headset user will be exposed during a selected time period is within the regulatory maximum level. Advantageously, the method and apparatus allow accurate real-time monitoring of cumulative exposure to headset noise and real-time adjustment of headset gain to ensure compliance with regulatory maximum sound exposure levels.

U.S. Pat. No. 6,456,199 B1 describes an apparatus adapted to be worn in an environment in which unsafe noise levels may be present for the purpose of continuously monitoring the noise level impinging upon the ear(s) of a user. The noise levels are monitored via a microphone housed within a hearing protective device, and located such that the noise level measured by the microphone is representative of the noise level impinging upon the ear(s) of the user when the hearing protective device is being worn in either a primary or secondary position. The noise level is recorded along with its duration to calculate a cumulative noise dose for an individual user, and to warn the user of when the noise dose exceeds a preset level.

U.S. Pat. No. 10,190,904 B2 describes methods of operating an audio device. A method includes measuring sound pressure levels (SPLECM) for acoustic energy received by an ear canal microphone (ECM) during a time increment Δt and calculating a SPL_DoseΔt during the time increment Δt using SPLECM.

U.S. Pat. No. 10,045,134 B2 describes a sound pressure level (SPL) monitoring information system. The system includes a database configured to store data including at least one of a list of earpiece devices and associated instrument response functions, an audiogram compensation information, or an earpiece frequency response function. The system further includes an SPL monitoring system comprising a microphone. The SPL monitoring system can be configured to receive a plurality of signals, were each signal represents a respective SPL of sound pressure values over a time duration for a particular frequency band. The SPL monitoring system is configured to determine at least one of: (a) an exposure time duration when at least one of the signals exceeds a SPL threshold value for the particular frequency band or (b) a recovery time duration when at least one of the signals is less than the SPL threshold value for the particular frequency band.

U.S. Pat. No. 9,848,257 B2 describes an earbud design. A displacement-based digital compression algorithm caps maximum output air displacement, as well as sound pressure level. Thus, an earbud is provided that, through adjustments and modularity, can act as a personal listening device, a hearing protection device, and as a personal aesthetic statement with customized fit and comfort.

U.S. Pat. No. 8,917,880 B2 describes a method of operating an audio device. The method includes: calculating estimated sound pressure levels (SPLs) for drive signals directed to an ear canal receiver (ECR) during a time increment Δt; calculating an estimated SPL_Dose during the time increment Δt using the estimated sound pressure levels; and calculating a total SPL_Dose at a time t of the audio device using the estimated SPL_Dose.

U.S. Published Patent Application No. 2008/0137873 A1 describes an earpiece that can include an Ambient Sound Microphone (ASM) to measure ambient sound, an Ear Canal Receiver (ECR) to deliver audio to an ear canal, an Ear Canal Microphone (ECM) to measure a sound pressure level within the ear canal, and a processor to produce the audio from at least in part the ambient sound, actively monitor a sound exposure level inside the ear canal, and adjust a level of the audio to within a safe and subjectively optimized listening level range based on the sound exposure level.

### SUMMARY OF THE EMBODIMENTS

The present invention relates to a system and method for managing a headphones user sound exposure. In particular, the method includes numerous process steps, such as: collecting sampled blocks of data related to the sound level experienced by the user directly by using a microphone to sample the sound level (internally and externally) and indirectly by using the audio data stream coming over a Bluetooth link and then computing an equivalent sound level based on this data. The method may also include: using the sampled data to compute SPL quantities from the time domain data and as a function of frequency from spectral data and storing these results at known time intervals. Next, the method may include: using the SPL and spectrum data to calculate a cumulative exposure level at known time intervals. The cumulative exposure data may be used to calculate a trend line (e.g., a line fit or curve fit) in order to estimate an amount of time until the cumulative exposure reaches a prescribed limit. When the time until the exposure limit becomes less than a threshold time, the method may include: incrementally reducing the users exposure to sound pressure, by means of reducing the total output level (e.g., by a net gain reduction, by using audio compression, or by specific spectrum band reductions as in an EQ change), or by increasing the reduction of ambient noise. Next, the method may include reducing the users sound level exposure such that the prescribed exposure limit is never exceeded. Further, the method may include: making the data available for upload to a smartphone or web service so user can track and understand their sound exposure over long periods of time.

It should be appreciated that, as described herein, “SPL” describes both a quantity derived from a root mean square of the time domain data and a quantity that is a function of frequency derived from a Fourier transform of the time domain data into a frequency domain. In common usage the term, SPL is often used to refer to a root mean square of a block of sampled data giving a single number. However in the more general case, the term SPL may describe a quantity as a function of frequency bands. Further, the SPL data as a function of frequency includes capturing the complete set of frequency data points or a small subset (e.g., the bass, mid, and high bands). As such, the SPL can be a single number or may have any number of spectral points.

A first embodiment of the present invention describes a method executed by Bluetooth-based headphones for managing a user sound exposure. The method includes numerous process steps, such as: collecting raw audio data. The raw audio data includes a first set of raw audio data from a first data source and a second set of raw audio data from a second data source and further audio related data from further sources. The first source differs from the second source and other sources. It should be appreciated that the quantity of sources is not limited to any particular number. The first set of raw audio data and the second set of raw audio data may be obtained simultaneously or at different intervals. In other examples, the first set of raw audio data and the second set of raw audio data are obtained at varying sample rates and sampling intervals. The first data source includes one or more internally faced microphones on the headphones or audio data from a Bluetooth audio data stream of the headphones. The second data source includes one or more externally facing microphones mounted on or nearby the headphones. It should be appreciated that, in some examples, the first data source, the second data source, and/or another data source may include Bluetooth audio data, internally facing microphones, and/or externally facing microphones.

Next, the method includes calculating the SPL from the raw audio data. The calculation of the time domain SPL occurs via a the root mean square (rms) of sampled audio data and the frequency domain SPL information via a fast Fourier transform (FFT) process. In most cases the spectral data obtained for the FFT calculation would be reduced to a small set of frequency bands e.g. bass mid high, rather than retained as the complete set of FFT points (which would be in the order of 1024 points).

Moreover, the calculation of the SPL from the raw audio data comprises: applying an algorithm or process to the first set of raw audio data to form a first set of calculated data, applying the algorithm or the process to the second set of raw audio data to form a second set of calculated data, storing the first set of calculated data in a first level data array, storing the second set of calculated data in a second level data array, and producing a first cumulative array comprising an integral of the first level data array and a second cumulative array comprising an integral of the second level data array.

Each data source, be it the Bluetooth audio stream digital data, a microphone voltage, etc., are sampled a number of times given by sample size at a sample interval given by sample rate. This data is normally scaled or otherwise conditioned so that it represents a sound pressure level in Pascals.

The sample data is then transformed to time domain SPL and frequency domain SPL and stored in a row of the levels data arrays with the time stamp. Each data source has an associated levels array. Then at some time interval, the levels array will be summed (integrated) to generate a cumulative figure and the cumulative number is stored in a row of the cumulative array with a timestamp. As such, each data source has an associated cumulative array.

Then, the calculation of the SPL from the raw audio data further comprises: arranging the first level data array, the second level data array, the first cumulative array and the second cumulative array as a circular buffers such that once the first level data array or the second level data array is filled, newest data overwrites oldest data and storing the first level data array, the second level data array, the first cumulative, and the second cumulative array in a non-volatile memory of the headphones. Each of the first level data array and the second level data array are stored with a timestamp. Further, the timestamp is an absolute time derived from a real-time clock or a relative time derived as an incremental value from a defined starting point.

Next, the method includes comparing the calculated SPL to a predetermined threshold level of sound exposure.

The cumulative array data is then used to calculate a trend line (either a line fit or curve fit). The trend line is then used to estimate the amount of time into the future at which the users cumulative sound exposure would reach a prescribed threshold. The time to limit is used to determine the “what if any adjustment” is needed to the controlled parameters.

The method then includes applying one or more parameters/modifications (e.g., active noise control (ANC), equalization (EQ), compression and/or a sound gain filter, among others) to reduce the SPL to ensure that the cumulative level never reaches the predetermined threshold level of sound exposure.

The principal here is that in the case of simple volume control, reducing the volume level would have the effect of lowering the slope of a line fit. That is to say that the slope of the cumulative array line fit is proportional to the volume level. In a similar manner, the cumulative array associated with the ambient noise level is related to the amount of noise cancellation such that increasing the noise cancellation would reduce the slope of the cumulative array line fit.

The method may also include transmitting the raw audio data, the spectral data, and/or the SPL to another device. Moreover, the method optionally includes: predicting a trend of the SPL.

In general, the present invention succeeds in conferring the following benefits and objectives.

It is an objective of the present invention to provide a system that reduces listening fatigue and protects hearing health.

It is an objective of the present invention to provide a system that autonomously manages the delivery of acoustic signals to a user's ears.

It is an objective of the present invention to provide a system that records the time history of the users acoustic exposure, calculate predictions of exposure, and modify, in real time, the ongoing delivery of acoustic signals.

It is an objective of the present invention to provide a system that evaluates a user's cumulative sound exposure and modifies the device parameters to avoid a user ever exceeding a prescribed maximum limit of sound exposure.

It is an object of the present invention to provide headphones or earphones incapable of producing a sound pressure level (SPL) high enough to cause damage over a time period less than the period required to develop extrapolated regression line that would allow for taper of the acoustic energy level delivered to the ear.

It is an object of the present invention to provide headphones or earphones with a mechanism for parental control over the listening levels and time exposure of their children.

### BRIEF DESCRIPTION OF THE DRAWINGS

FIG. 1, FIG. 2, and FIG. 3 depict schematic diagrams of a process/chain of collecting raw audio data through to calculating a cumulative array, according to at least some embodiments disclosed herein.

FIG. 4 and FIG. 5 depict schematic diagrams of a system configured to protect a user's hearing health, according to at least some embodiments disclosed herein.

FIG. 6 depicts a typical sample rate and sample block size calculation that may be performed, according to at least some embodiments disclosed herein.

FIG. 7 depicts a graph plotting level data arrays, according to at least some embodiments disclosed herein.

FIG. 8 depicts a graph plotting an on/off status of a device on an x-axis and an SPL in RMS on a y-axis, according to at least some embodiments disclosed herein.

FIG. 9 depicts a graph showing cumulative sound energy and a limit of the cumulative sound energy, according to at least some embodiments disclosed herein.

FIG. 10 depicts a graph showcasing a time to limit, according to at least some embodiments disclosed herein.

FIG. 11 depicts tables for SPL and timestamp, according to at least some embodiments disclosed herein.

FIG. 12 depicts a graph representing a time on an x-axis and a cumulative sound energy on a y-axis, according to at least some embodiments disclosed herein.

FIG. 13 depicts a schematic diagram of a process/chain of collecting raw audio data through to calculating a cumulative array, according to at least some embodiments disclosed herein.

FIG. 14 depicts a graph showcasing standards for sound exposure by OSHA, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As described herein, “active noise control,” “ANC,” “noise cancellation,” “active noise reduction,” or “ANR” is a method for reducing unwanted sound by the addition of a second sound specifically designed to cancel the first.

As described herein “sound pressure level” or “SPL” is a logarithmic measure of the effective pressure of a sound relative to a reference value.

As described herein, a “root mean square” or “RMS” is the square root of the mean square (the arithmetic mean of the squares of a set of numbers).

As described herein, “Bluetooth” is a wireless technology standard used for exchanging data between fixed and mobile devices over short distances using UHF radio waves in the industrial, scientific and medical radio bands, from 2.402 GHz to 2.480 GHz, and building personal area networks.

As described herein, “Bluetooth Low Energy” is a wireless personal area network technology aimed at applications in the healthcare, fitness, beacons, security, and home entertainment industries. When compared to classic Bluetooth, Bluetooth Low Energy is intended to provide considerably reduced power consumption and cost while maintaining a similar communication range. Mobile operating systems including iOS, Android, Windows Phone and BlackBerry, as well as macOS, Linux, Windows 8 and Windows 10, natively support Bluetooth Low Energy.

It should be appreciated that “headphones” may be used interchangeable with “headsets” or “ear buds” herein.

As described herein, “equalization” or “EQ” is the process of adjusting the balance between frequency components within an electronic signal. The most well-known use of equalization is in sound recording and reproduction but there are many other applications in electronics and telecommunications.

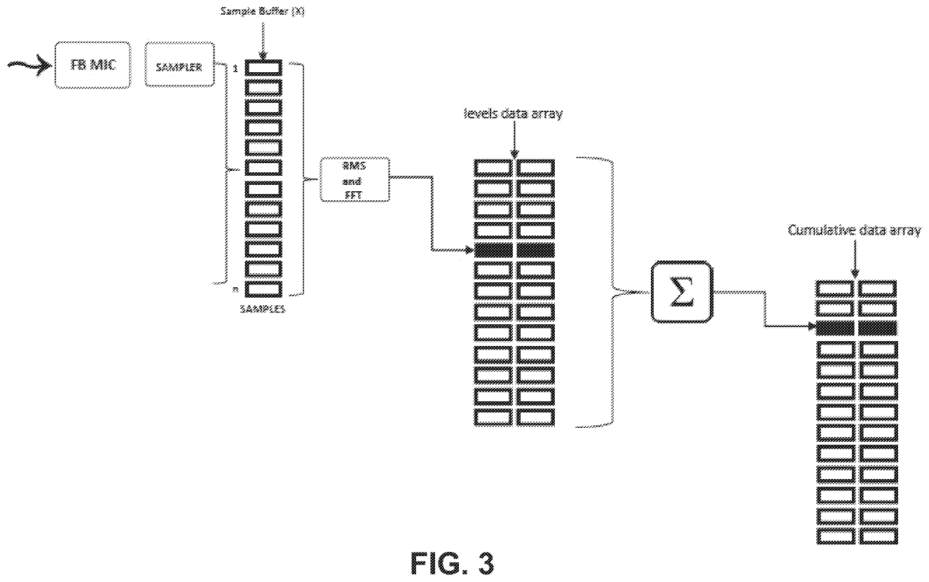

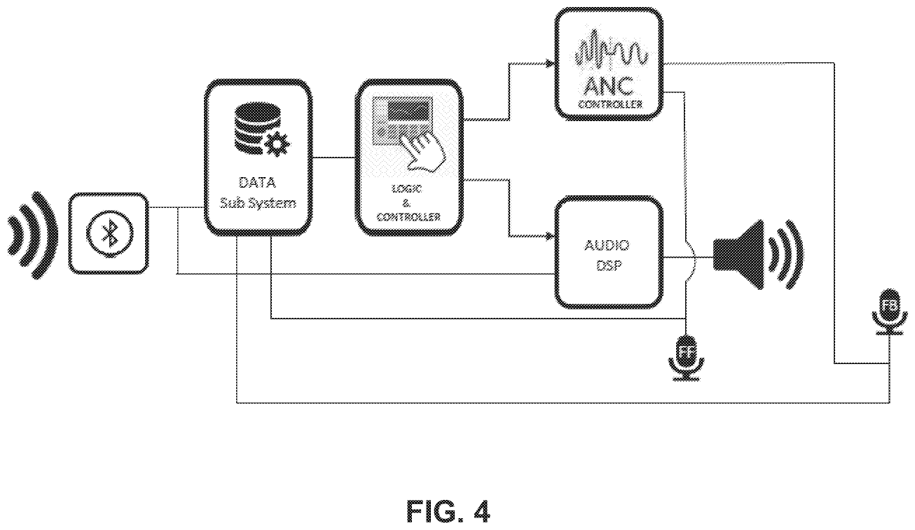

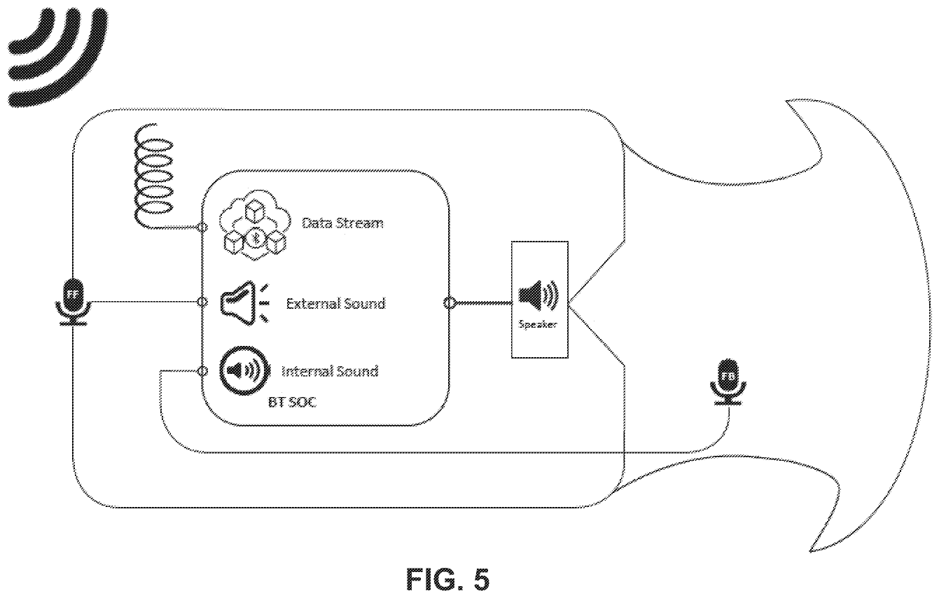

A system described and depicted at least in FIG. 4 and FIG. 5 reduces listening fatigue and protects hearing health. The system executes several process steps in a continuous fashion and provides a closed-loop system. Specifically, the system collects an ongoing record of acoustic signals, uses this data to calculate acoustic exposure to a user wearing headphones and predict the trend of the exposure, applies parameters to the acoustic signals to adjust the acoustic exposure, and provides a means to transmit data to another to allow the user to create a long term log of audio exposure. As such, the system autonomously manages the delivery of acoustic signals to a user's ears.

Furthermore, as described herein, a “sound exposure” is framed in terms of an equivalent continuous sound pressure level and is defined by the following expression:

$${L}_{eq} = 10 {log}_{10} ( \frac{1}{{T}_{M}} {\int }_{Q}^{{T}_{M}} {( \frac{P ( t )}{{P}_{0}} )}^{2} dt ) ,$$

In the above expression, P(t) is the sound pressure in pascals at time t, Pₒ is the reference sound pressure level 2e-5 pascals, the integral is performed over the interval Q to Tₘ, Q represents a zero point in time, Tₘ is the period of time the integration extends, and L_{eq} is a sum of the squares of sound pressure level over time. As such, the integral term describes a total exposure and the maximum allowable exposure is approximately equal to a constant, as shown:

$$Total Exposure = {\int }_{0}^{T} {p ( t )}^{2} dt ⩽ Maximum Exposure$$

A method executed by Bluetooth-enabled headphones for managing a user sound exposure is also described herein. The method comprises numerous process steps, such as collecting raw audio data. The raw audio data may include a first set of raw audio data from a first data source and a second set of raw audio data from a second data source. It should be appreciated that the first source differs from the second source. Moreover, in examples, the first data source may include one or more internally faced microphones on the headphones, which may sense sound pressure inside the front cavity, such as a feedback ANC microphone, via an analog-to-digital converter (ADC).

In another example, the first data source may include a Bluetooth audio data stream of the headphones and the first set of raw audio data may include Bluetooth audio or voice data. In a further example, the second data source may include one or more externally facing microphones mounted on or nearby the headphones. Examples of such include an inline voice microphone, a feed forward ANC microphone or boom microphone, via the ADC.

In some examples, the first set of raw audio data and the second set of raw audio data are obtained simultaneously in systems that have sufficient processing power. The system's ability to provide for continuous sampling of the incoming audio data stream, before it is reproduced as an acoustic signal, allows for immediate truncation and compression of the signal to avoid excessively SPL levels. In some applications, this situation would be prevented by design, and therefore, the need for the continuous sampling would be avoided. However, this solution is computationally expensive and would consume a relatively high amount of power. In other examples, the first set of raw audio data and the second set of raw audio data are obtained at varying sample rates and sampling intervals, where these intervals may be periodic (e.g., at a few times per second up to periods of several seconds).

Using multiple sources of data allows the system to differentiate between noise originating from program audio content and noise originating from ambient noise, as well as allowing for the ability to self-calibrate. Self-calibration may occur where a feedback microphone produces a direct measurement of sound pressure level that can then be used to calibrate the scaling factor applied to the Bluetooth digital data, where the scaling of the Bluetooth digital data gives an equivalent sound pressure level number.

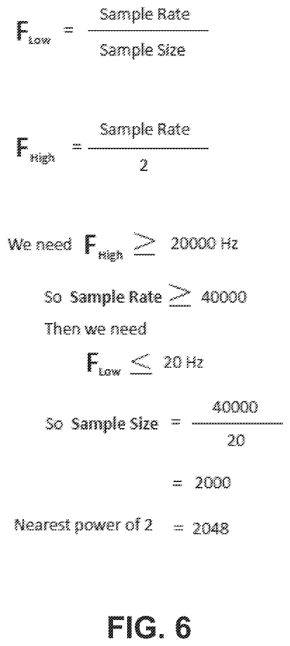

It should be appreciated that a sample data block size may be chosen so that a fast Fourier transform (“FFT”) of the data produces frequencies that adequately cover the relevant frequency spectrum, as shown in FIG. 6. In FIG. 6, the lowest frequency that can be resolved by an FFT is given by the sample rate divided by the sample size and the highest frequency given by the sample rate is divided by 2. Next, one decides that the highest frequency point should be at least 20 kHz and so one can get the required sample rate. Then, one decides that the lowest frequency should be 20 Hz. Using the previously determined sample rate and the equation for the lowest frequency, one can determine the required sample size. Finally, the sample size is typically rounded to an integer power of 2 to allow for an optimized FFT calculations.

As described herein, “a fast Fourier transform” or “FFT” is an algorithm that computes the discrete Fourier transform (DFT) of a sequence, or its inverse (IDFT). Fourier analysis converts a signal from its original domain (often time or space) to a representation in the frequency domain and vice versa. The DFT is obtained by decomposing a sequence of values into components of different frequencies. FIG. 6 depicts a typical sample block size calculation that may be performed. In most cases, the sample block size can be rounded to the nearest integer power. This gives advantages for the subsequent FFT calculation.

Moreover, it should be appreciated that the data in each buffer is scaled to represent a common unit of measurement, such as the Pascal unit, referring to sound pressure at the ear of the user. As an example, in the case of a microphone signal sampled by the ADC, a scale factor may have the units, Pascals per ADC Code. The buffer is a block of memory that holds the block of sampled data, with one buffer being used for each data source. The data in the buffer is not retained once the calculation of SPL and spectrum data is completed. Instead, the buffer is then used for the next block of sampled data.

A scale factor is needed to convert the raw sample data into a common unit of measure. For example, the Bluetooth audio data comprises digital numbers that represent a waveform, The acoustic pressure that will result from playing this waveform through a DAC amplifier and speaker is proportional to the digital number. The scale factor one uses accounts for this proportion so that when one scales the Bluetooth audio data numbers accordingly, one gets the equivalent pascals of sound pressure that the user will experience.

In the case of digital audio data obtained from a Bluetooth data stream, the scale factor would have the form of Pascals per digital code, but may also have an additional factor (e.g., the net system gain). This gain would change with user adjustment of equalization (EQ) and volume controls.

It is preferred that the system makes use of the data source already available in a given headphone design so that no additional component cost is incurred when implementing the instant system. Systems can therefore function with any combination of available sources. For example, the most basic implementation would include access only to Bluetooth digital data. An advanced implementation would include access to feedforward ANC microphones, feedback ANC microphones, and Bluetooth digital data.

Next, the method may include calculating spectral data and the SPL RMS values from the raw audio data The spectral data is calculated using an FFT calculation. The SPL however can be computed with a relatively simple formula as below. The FFT takes a block of sampled data that represent a waveform in time and transforms it to a set of frequency components. The FFT tells us the magnitude (level) of each frequency component that makes up the waveform. From this information, one can determine which frequency components have the greatest influence on the total sound pressure level and thereby allows one to selectively reduce those frequency components without having to attenuate the entire signal. The SPL calculation may occur by the following equation:

$$SPL ( t ) = 20 {Log}_{10} [ \frac{\sqrt{{\sum }_{1}^{N} {( {X}_{n} A )}^{2}}}{2 \times {10}^{- 5}} ]$$

In the above-referenced equation, Xₙ is the nth data sample, A is the scaling factor that transforms Xₙ into the equivalent pascals of sound pressure, the summation is performed over the range of 1 to N samples, N is the total number of samples in our sample data buffer, and SPL(t) is the SPL at the time point t (when the calculation is made).

It should be appreciated that in some examples, data may be computed only as the means of the squares, where the square root is not performed. This is done so that computing an accumulated acoustic energy number does not need to ‘undo’ the square root function (given the accumulated acoustic energy is based on the square of sound pressure). The use of RMS is interchangeable with the means of the squares, albeit in practice at the computation cost of a square or square root function. The complete block of sampled data is transformed with the FFT or SPL calculations.

The spectral data resulting from the FFT process may be reduced in size so that wide frequency ranges would be characterized by a single number. In one case, the ranges could be reduced to represent just bass, mid, and treble frequency ranges, thereby only requiring three numbers to be stored. However, in host chips with sufficient memory capacity, the complete set of FFT frequency bins could be stored.

The calculation may form/generate a first set of calculated data and a second set of calculated data. Next, the first set of calculated data may be stored in a first level data array and the second set of calculated data may be stored in a second level data array. Each element or row of the first level data array and the second level data array encapsulates the information from a block of sampled data. There is one level data array for each data source, such that the information from each data source is maintained independently. As such, the level data provides a momentary snapshot of the acoustic sound pressure at a particular point in time.

Moreover, in the general case, the level data stored in the first level data array and the second level data array is not required to be regularly spaced in time. In some cases, it may be preferably to dynamically modify the period of sampling and the data calculation to reduce power consumption, when, for example, a very consistent level of acoustic signal is detected, a longer period of between samplings can provide an adequate characterization of the acoustic signal within that period. Conversely, when the acoustic signal has relatively long periods of silence with short burst of high level signal, a shorter interval of samplings would be required to adequately capture the high level bursts.

The length of the first level data array and the second level data array, and therefore the time span of the measurements, may be user-defined/user-customizable and may constrained by available memory in the underlying device. However, this would typically be in the range of several seconds up to twenty-four hours. In some case is would be possible (given sufficient data storage) to have an unlimited length.

A first cumulative array may be produced that includes an integral of the first level data array and a second cumulative array may be produced that includes an integral of the second level data array, as shown below:

$${C}_{SE} = {\sum }_{1}^{N} ( SPL ( n ) {t}_{n + 1} - {t}_{n} )$$

Given the general case, each of the first level data array and the second level data array may have arbitrary time spacing, where each element of the first level data array and the second level data is multiplied by its associated time period. In the case that all elements occur with an identical period, the cumulative array becomes the sum of the first level data array and the second level data multiplied by the total time. Further, the cumulative array data element is given an absolute of relative timestamp. The cumulative array would most often be updated at a slower rate than the first level data array and the second level data, but could be equal to the levels array period.

The first level data array, the second level data array, the first cumulative array, and the second cumulative array may be arranged as a circular buffers such that once the first level data array or the second level data array is filled, newest data overwrites oldest data. Each of the first level data array and the second level data array comprise information regarding momentary sound exposure levels. Further, the first and second cumulative arrays provides information regarding a total sound energy over a time period.

In examples, each of the first level data array and the second level data array are also stored with a timestamp. In some examples, the timestamp is an absolute time derived from a real-time clock. In other examples, the timestamp is a relative time derived as an incremental value from a defined starting point. Further, the first level data array, the second level data array, first cumulative array and the second cumulative array may be stored in a non-volatile memory of the headphones. In some examples, the first level data array, the second level data array, first cumulative array and the second cumulative array may be stored in a Bluetooth chip of the headphones. The Bluetooth chip may further provide processing hardware used for at least a subset of the process steps described herein. As such, the technology described herein can be implemented without a need for additional equipment, and as such, is cost-effective.

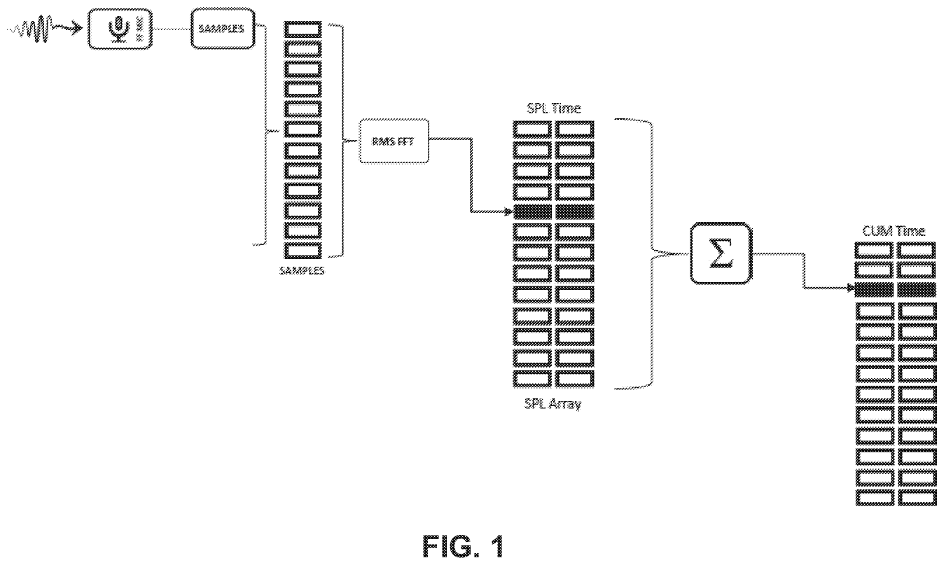

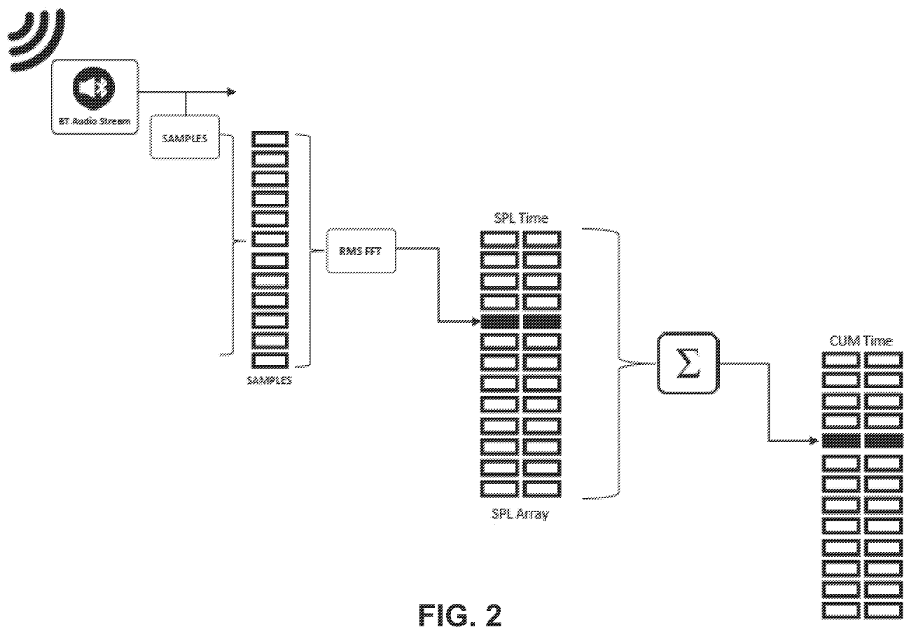

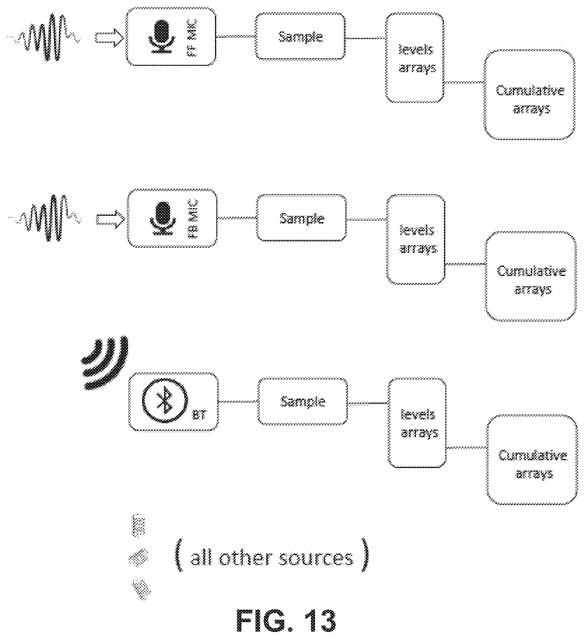

The process/chain of collecting the raw audio data through to calculating the cumulative array may be depicted in FIG. 1, FIG. 2, FIG. 3, and FIG. 13. As depicted in FIG. 1, FIG. 2, FIG. 3, and FIG. 13, and as explained previously, a number of audio samples are collected from one or more data sources. In the next step, the block of samples are then processed by RMS and FFT calculations to produce SPL information at a given time point. The data is then stored in a memory array along with the time reference. Then, the SPL arrays are periodically summed. The data is stored in a cumulative data array, which is also associated with a time reference. The SPL arrays give information about momentary sound level and the cumulative array gives information about the total sound energy over a period of time.

It should be appreciated that in some examples, the system provides the user with the ability to clear the existing memory of levels and cumulative arrays, which are preferably stored in non-volatile memory so that when the device is powered-off and subsequently powered-on, the data is retained and the system can continue to operate, while including the information about prior levels and cumulative data.

While the headphones host chipset provides only limited non-volatile data storage, the levels and cumulative data can be summarized into a reduced sets of values that represent key aspect of the information normally stored in the levels and cumulative arrays. For example, an RTC may often provide a very low power persistent data storage space. The cumulative data arrays could be reduced to single value and the time period it represents to capture the key information from the entire cumulative array. When the device is powered off, this summary data is stored to the RTC memory. When the device is powered on, this information is recovered and used to seed the cumulative array with a starting point that represents the prior total cumulative data.

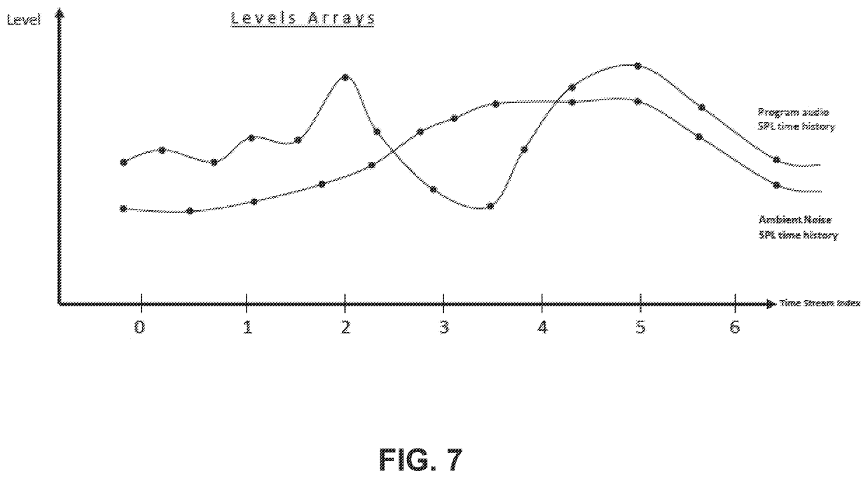

FIG. 7 depicts a graph having an x-axis of time and a y-axis of level. FIG. 7 depicts level data arrays, and in particular, program audio SPL time history and ambient noise SPL time history. As shown in FIG. 7, the cumulative array element is the area under the curve. This behavior is modified critically by the use of the timestamp described herein. The cumulative array would in fact evaluate the levels data arrays over a given time window, typically 24 hours. The broadest possible range is in fact an unlimited period of time, however a somewhat extreme case would be perhaps a 1 week time window. Moreover, in the case where the user stopped using the device (e.g., headphones) for several hours, the levels array may still contain data older than the cumulative time window of 24 hours. As such, the older data would not be included in the calculation of the cumulative value.

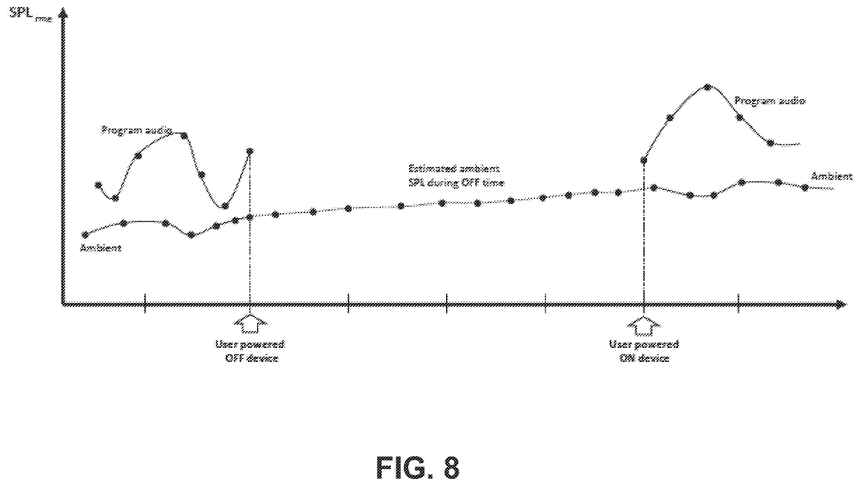

Next, FIG. 8 depicts a graph having an x-axis of a status of the device (e.g., powered off or powered on) and a y-axis of SPL in RMS. As shown in FIG. 8, the system could assume that when the device (e.g., headphones) are powered off, a ‘zero’ level is applied. However, in the case of ambient noise, the system may assume that the user will still be subjected to the same ambient noise during the powered-off period, especially when the system finds the ambient noise level is the same when powered-on and may apply an estimated non-zero value for the powered-off period.

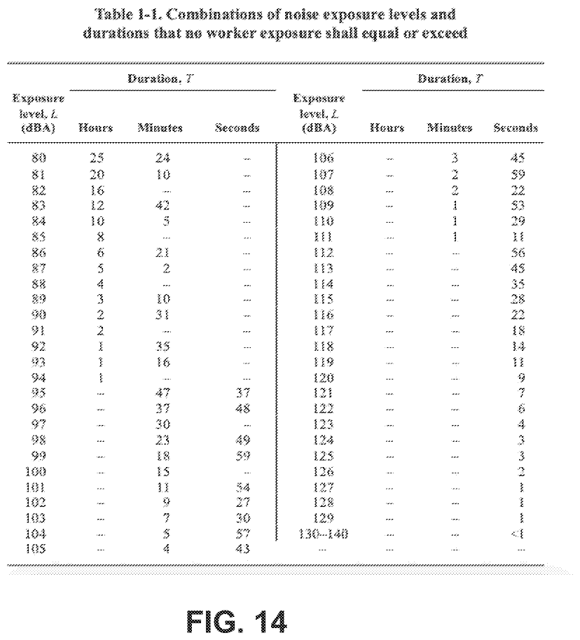

Moreover, the system includes the concept of a “limit cumulative value” and a “time to limit” value. The limit cumulative value parameter represents a maximum allowable acoustic energy exposure. This value may be user-defined or prescribed to align with international standards for sound exposure, such as by the OSHA and/or WHO, as depicted in FIG. 14. It should be appreciated that FIG. 14 was taken from United States Department of Health and Human Services, “Occupational Noise Exposure Revised Criteria 1998,” June 1998, the entire contents of which are hereby incorporated by reference in their entirety.

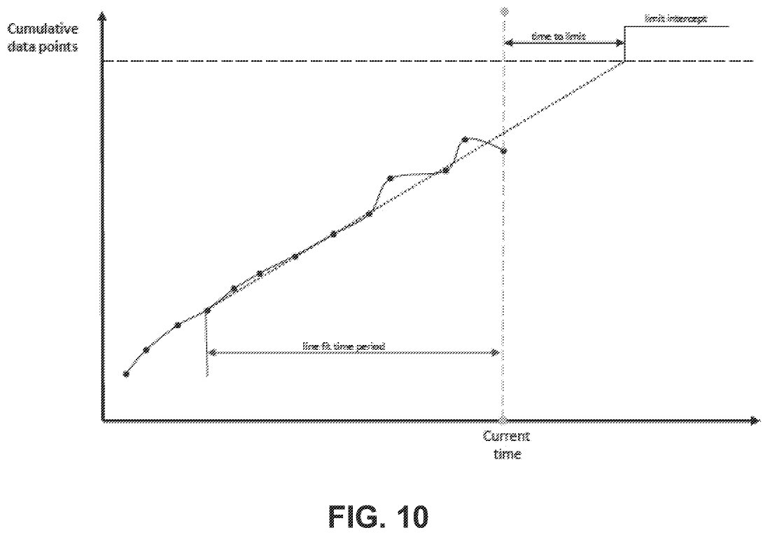

FIG. 10 depicts a graph having an x-axis of current time and a y-axis of cumulative data points. As explained herein, the time to limit value represents an estimate of how long until the exposure limit is reached based on historical conditions. The cumulative data array at any time has a “current” element. A line fit is performed by linear regression of a given number or points preceding the current time point. The regression line is then extrapolated to determine an intercept with the limit. The actual time between the current time and the limit line intercept is determined, called the “time to limit,” as seen in FIG. 10.

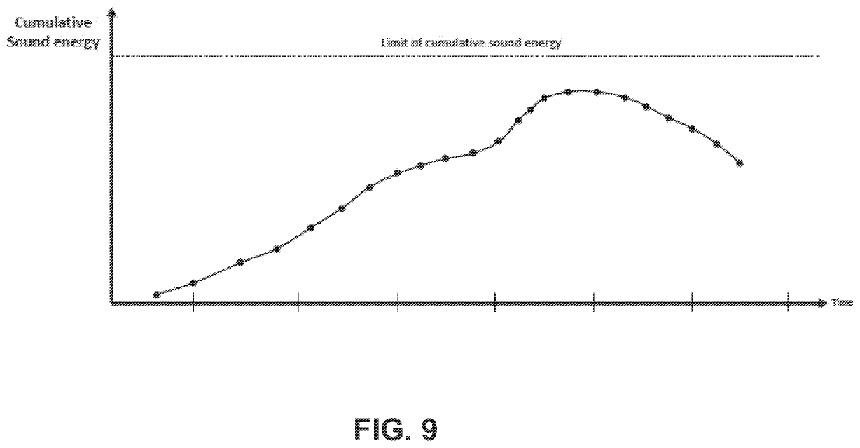

The method may also include comparing the sound exposure to a predetermined threshold level of sound exposure. In response to a determination that the sound exposure is approaching the predetermined threshold level of sound exposure, the method may further include applying one or more parameters to the sound exposure to reduce the sound exposure to ensure the sound exposure never reaches the predetermined threshold level of sound exposure, as depicted in FIG. 9. Such parameters are applied automatically and autonomously. The parameters may include active noise control (ANC), equalization (EQ), compression and/or a sound gain filter, among others. More specifically, the control parameters may be: gain of the ANC system, net gain of the audio path (e.g., volume control), gain of a specific EQ filter band, shape of an EQ filter function usually realized in the form of a biquad digital filter whereby the filter coefficients can be adjusted, and/or audio compressor compression controls. It should be appreciated that gradual and incremental changes are made to the EQ, net gain, and ambient noise cancellation levels to ensure that a user's cumulative exposure to acoustic signal never reaches a damaging level or indeed a level that would lead to listening fatigue.

In the case of an EQ change, the system includes a DSP equalizer aspect, usually in the form of a digital biquad filter structure with variable coefficients. When a particular band requires gain adjustment, the appropriate coefficient value in modified in the DSP system and the biquad filter changes the effective gain of that frequency band. This approach is particularly useful in cases where, for example, heavy bass levels are present in the audio content source that drive up the sound exposure level, while the rest of the frequency spectrum is contributing very little to the total exposure. In this situation, the bass gain could progressively be reduced such that the user may continue to listen to the content at a similar overall level, with only the bass frequencies being attenuated. In practice, while a gradual adjustment takes place, a user's psychoacoustic experience compensates for the reduction in low frequency output and the change goes unnoticed and does not detract for the user enjoyment.

In another example, the ANC system may have a range of available gain. When the ambient noise is contributing significantly to the users sound exposure, an increase in the noise reduction effect would limit the user cumulative exposure gradient without detracting for the listening experience, activation of this part of the system would require either or both of a feedforward and feedback microphone to enable discrimination of ambient noise compared to program audio material.

It should be appreciated that the simplest system that does not have variable EQ parameters or ANC would allow only a net system gain change. In this case, the principal applies identically, however, only the net system gain can be adjusted to taper the user cumulative sound level exposure.

In another example, if the time to limit exceeded a specified amount (e.g., 3 hours), the EQ and gain maximum may be increased by an increment value. In another example, if the time to limit exceeded a specified amount (e.g., 2 hours), but is less than 3 hours, no change is made. In a further example, if the time to limit is less than a specified amount (e.g., 2 hours), the system may reduce in the overall gain or gain of a specific frequency band by an increment amount. It should be appreciated that the EQ or gain change would lead to a lower value in the levels array and consequently a smaller increase in the cumulative array. This smaller increase would then cause the regression line to flatten out and thereby increase the time to limit. The system would be tuned such the cumulative level would be forced to asymptote to the limit level, but never exceed it.

The amount of EQ band or overall gain change may be defined as a fixed increment or may be computed from the cumulative array data curve fit. In this method, one can calculate a line gradient that gives an intercept at the minimum required time point (e.g., 2 hours). Then, calculation of the cumulative level increment, in the next element, would give the required gradient. Then, the differences are found between the desired increment and the mean increment across the preceding points. This difference in increment is then the dB gain level change required. The system response may further be controlled by adding additional criteria to the change, for example, that the increment may not be greater than a given value (e.g., less than 1 dB) so that the user would not readily notice a step change in listening level, rather very gradual taper is applied such that the users listening experience is not interrupted.

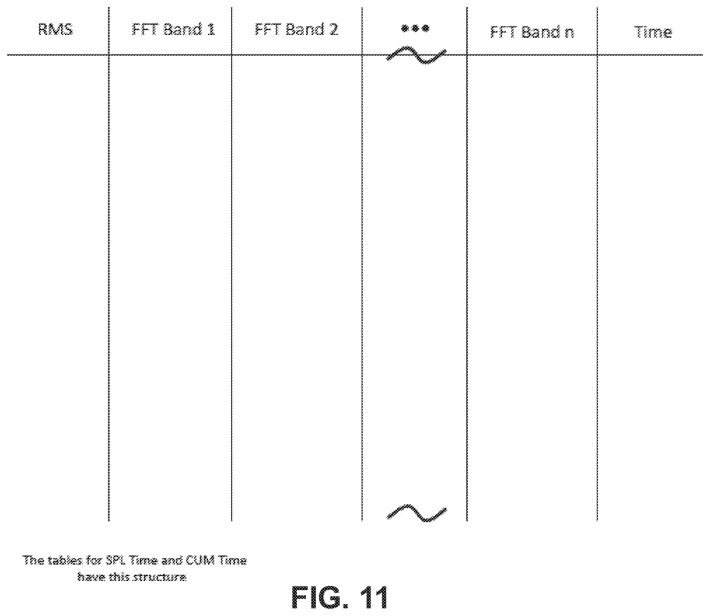

It should be appreciated that the computational functions here in the preferred embodiment would be completely executed on the Bluetooth chip. Given the periodic nature of the sampling, levels array calculations, cumulative array calculations and line intercept calculations, the demand on processing could be within reasonably limits. Example tables for the SPL time and the cumulative time are depicted in FIG. 11.

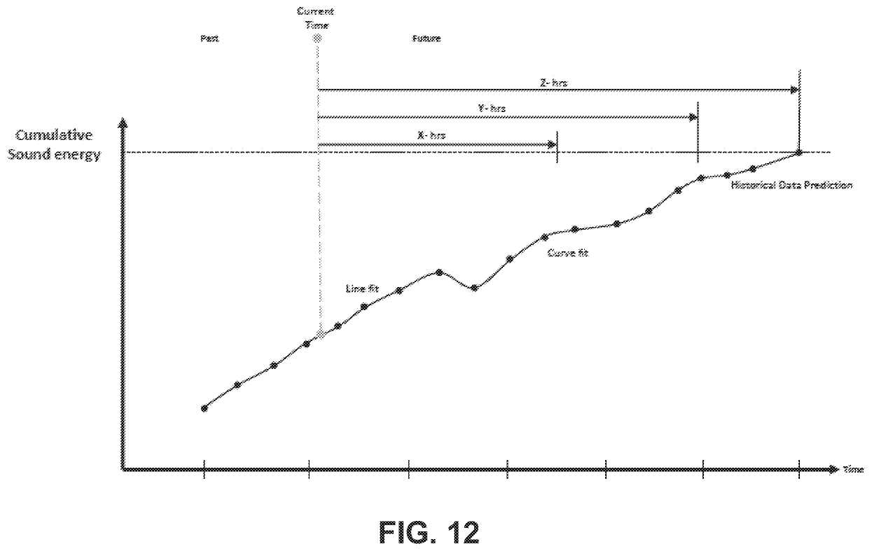

FIG. 12 depicts a graph having an x-axis of time and a y-axis of cumulative sound energy. The method may optionally include a step to predict a trend of the sound exposure is depicted in FIG. 12.

Next, the method may include transmitting the raw audio data and/or the sound exposure to another device. This other device may be a smartphone, a PC, a facility, or a cloud-based server, among others. This means that the local device may retain data that spans a relatively limited time frame, e.g. 24 hours, while the connected device (e.g., the other device) may retain an unlimited span of data. This data logging ability allows users to access a historical record of acoustic energy exposure over long time frames and additionally allows users to observe patterns of sound exposure that may facilitate behavioral changes to help to protect hearing health. For example, a user may discover that their exposure to high levels of acoustic energy always occur in a specific circumstance for which they may be able to avoid.

It should be appreciated that the system (e.g., the headphones) described herein is designed such that it is incapable of producing an SPL level high enough to cause damage over a time period less than the period required to develop extrapolated regression line that would allow for taper of the acoustic energy level delivered to the ear of the wearer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by an audio playback device for managing a user sound exposure, the method comprising:
collecting raw audio data;
calculating SPL data from the raw audio data;
comparing the calculated SPL to a predetermined threshold level of sound exposure; and
in response to a determination that the SPL is approaching the predetermined threshold level of sound exposure, applying one or more modifications to the SPL to reduce the SPL to ensure the SPL never reaches the predetermined threshold level of sound exposure.

2. The method of claim 1,
wherein the raw audio data comprises a first set of raw audio data from a first data source, a second set of raw audio data from a second data source, and a third set of raw audio data from another data source, and
wherein the first source differs from the second source.

3. The method of claim 2,
wherein the first data source is selected from the group consisting of: one or more internally faced microphones on the audio playback device and a Bluetooth chip memory of the audio playback device, and
wherein the second data source comprises one or more externally facing microphones mounted on or nearby the audio playback device.

4. The method of claim 2, wherein the first set of raw audio data and the second set of raw audio data are obtained simultaneously.

5. The method of claim 2, wherein the first set of raw audio data and the second set of raw audio data are obtained at varying sample rates and sampling intervals.

6. The method of claim 1, wherein the calculation of the SPL occurs via a fast Fourier transform (FFT) process.

7. The method of claim 2, wherein the calculation of the SPL from the raw audio data comprises:
applying an algorithm or process to the first set of raw audio data to form a first set of calculated data; and
applying the algorithm or the process to the second set of raw audio data to form a second set of calculated data.

8. The method of claim 7, wherein the calculation of the SPL from the raw audio data calculation further comprises:
storing the first set of calculated data in a first level data array;
storing the second set of calculated data in a second level data array; and
producing a cumulative array comprising an integral of the first level data array and the second level data array.

9. The method of claim 8, wherein the calculation of the SPL from the raw audio data calculation further comprises:
arranging the first level data array, the second level data array, and the cumulative array as a circular buffer such that once the first level data array or the second level data array is filled, newest data overwrites oldest data; and
storing the first level data array, the second level data array, and the cumulative array in a non-volatile memory of the audio playback device.

10. The method of claim 8, wherein each of the first level data array and the second level data array are stored with a timestamp.

11. The method of claim 10, wherein the timestamp is an absolute time derived from a real-time clock or a relative time derived as an incremental value from a defined starting point.

12. The method of claim 1, further comprising:
transmitting the raw audio data, the spectral data, and/or the SPL to another device.

13. The method of claim 1, wherein each modification of the one or more modifications are selected from the group consisting of: active noise control (ANC), equalization (EQ), and a sound gain filter.

14. The method of claim 1, wherein the audio playback device comprises headphones.

15. The method of claim 1, further comprising:
predicting a trend of the SPL.

16. A method executed by an audio playback device for managing a user sound exposure, the method comprising:
collecting raw audio data;
calculating SPL data from the raw audio data;
comparing the calculated SPL to a predetermined threshold level of sound exposure;
in response to a determination that the SPL is approaching the predetermined threshold level of sound exposure, applying one or more modifications to the SPL to reduce the SPL to ensure the SPL never reaches the predetermined threshold level of sound exposure, wherein each modification of the one or more modifications are selected from the group consisting of: active noise control (ANC), equalization (EQ), and a sound gain filter; and
transmitting the raw audio data, the spectral data, and/or the SPL to another device.

17. The method of claim 16, wherein the calculation of the SPL from the raw audio data comprises:
applying an algorithm or process to the first set of raw audio data to form a first set of calculated data; and
applying the algorithm or the process to the second set of raw audio data to form a second set of calculated data.

18. The method of claim 17, wherein the calculation of the SPL from the raw audio data calculation further comprises:
storing the first set of calculated data in a first level data array;
storing the second set of calculated data in a second level data array, and
producing a cumulative array comprising an integral of the first level data array and the second level data array.

19. The method of claim 18,
wherein each of the first level data array and the second level data array comprise information regarding momentary SPLs, and
wherein the cumulative array provides information regarding a total sound energy over a time period.

20. The method of claim 18, wherein the calculation of the SPL from the raw audio data calculation further comprises:
arranging the first level data array, the second level data array, and the cumulative array as a circular buffer such that once the first level data array or the second level data array is filled, newest data overwrites oldest data; and
storing the first level data array, the second level data array, and the cumulative array in a non-volatile memory of the audio playback device.
